(19) United States
(12) Patent Application Publication
(10) Pub. No.: US 2024/0317604 A1
(43) Pub. Date: Sep. 26, 2024

(54) PROCESS FOR PRODUCING HIGH PURITY NICKEL SULFATE

(71) Applicant: TODA KOGYO CORP., Hiroshima-shi, Hiroshima-ken (JP)

(72) Inventors: Tomohiro HONDA, Otake-shi, Hiroshima-ken (JP); Anyu ZHANG, Otake-shi, Hiroshima-ken (JP); Masayuki YOKOTA, Otake-shi, Hiroshima-ken (JP); Nobuyuki TAGAMI, Otake-shi, Hiroshima-ken (JP)

(21) Appl. No.: 18/578,923

(22) PCT Filed: Jul. 7, 2022
(86) PCT No.: PCT/JP2022/026911

§ 371 Date: Jan. 12, 2024

(30) Foreign Application Priority Data
Jul. 16, 2021 (JP) 2021-118343

(51) Int. Cl. C01G 53/10; C01D 5/02; C01D 5/16

(52) U.S. Cl. CPC C01G 53/10; C01D 5/02; C01D 5/16

(57) ABSTRACT

The present invention is to provide a process for removing magnesium contained as an impurity from nickel sulfate and producing high-purity nickel sulfate.

The process for producing an aqueous nickel sulfate solution from which magnesium is removed from nickel sulfate, comprises the following steps (1) to (3):
(1) a carbonation step obtaining a slurry comprising nickel carbonate as a solid content by mixing a nickel sulfate aqueous solution and lithium carbonate,
(2) a solid-liquid separation step of separating the slurry obtained in the carbonation step into a solid content and liquid component, and
(3) a dissolution step dissolving the solid content obtained in said solid-liquid separation step with a solution containing sulfuric acid.

### TECHNICAL FIELD

The present invention relates to a process for producing high-purity nickel sulfate. More particularly, the present invention relates to a process for removing magnesium from nickel sulfate, particularly those contained as impurities. The present invention can be applied to nickel sulfate aqueous solutions generated in a step of nickel extraction from ore, in a step of recycling lithium ion secondary batteries or in a step of acid-treatment of lithium nickel composites.

### BACKGROUND ARTS

Nickel sulfate is obtained as a product or by-product via a step of nickel extraction from ore, a step of recycling lithium ion secondary batteries or a step of acid-treatment of lithium nickel composites. The nickel sulfate thus obtained is used as a synthetic raw material such as a positive electrode material of lithium ion secondary batteries, a positive electrode material of primary batteries and various catalysts.

When nickel sulfate is used as a raw material for the above applications, a high purity is required as one of important physical properties of nickel sulfate. In order to meet this request, a crystallization method, a solvent extraction method and a precipitation method using an alkali hydroxide have been developed as a method of purifying nickel sulfate.

While by these developed purification methods, it is possible to efficiently remove the main polyvalent metal impurity elements except for magnesium, there is not established an industrial process in which only magnesium can be efficiently removed.

For magnesium removal by a crystallization method, in non-patent literature 1, it has been reported that a cooling crystallization method tends to mix sodium, chlorine and magnesium into nickel sulfate crystals and magnesium is more likely to remain in nickel sulfate compared to the other elements. As shown in this example, the removal of magnesium using the crystallization method is not an efficient technique.

For magnesium removal by solvent extraction techniques, Patent Document 1 describes a technique for countercurrent flow contacting an organic phase holding nickel with a crude nickel sulfate solution containing impurities and separating the impurities from nickel by a displacement reaction. Although the magnesium in the nickel solution can be reduced by this method, the removal rate is low because the reaction behavior of magnesium is similar to nickel. As can be seen from this example, the solvent extraction method is not a technique which can efficiently remove magnesium from nickel sulfate.

For magnesium removal by precipitation techniques, Patent Document 2 describes a process comprising adding an alkali hydroxide such as calcium hydroxide into an aqueous nickel sulfate solution containing magnesium as an impurity, recovering nickel as a nickel hydroxide precipitate by solid-liquid separation, separating magnesium as the filtrate, and separating and recovering the dissolved magnesium as a precipitate by neutralization.

This process is a method utilizing properties of different pH at which nickel and magnesium is precipitated in an aqueous solution. However, the pH difference is not large and this process requires a very high technique to operate to maximize the yield of nickel while avoiding co-precipitation of magnesium. Therefore, this process is not an advantageous process. Also, the nickel hydroxide precipitate obtained by the addition of alkali hydroxide has a strong tendency to precipitate as fine particles. When treating a large amount of nickel sulfate, there are such problems of inhibiting practical operation that efficiency is lowered due to the slow filtration rate, a relatively huge solid-liquid separation device is required to obtain an appropriate filtration rate, or a special filtration device should be introduced thereby reducing economic efficiency. Therefore, this process is not an effective process.

Also Patent Document 3 discloses a method of combining a carbonation step, a solid-liquid separation step and a neutralization step in order to selectively separate and remove magnesium contained in an aqueous nickel sulfate solution. The use of the technique of carbonation facilitates pH adjustment compared to the case of using alkali hydroxide, and it is expected that the filterability of the precipitate will be improved. However, it is a problem that the high magnesium removal rate as obtained by the pH adjustment method described in Patent Document 2 cannot be attained. Also, when operating under such conditions as to increase the removal rate of magnesium, it is also a problem that the yield of nickel which is the main component is significantly reduced. Thus, it is possible to reduce the magnesium, but is not an efficient technique as a magnesium removal technique, which achieves both the yield of nickel and the magnesium removal rate.

Also Patent Document 4 discloses a combination of a hydroxylation step, a carbonation step, a solid-liquid separation step, and a neutralization step. By use of this technique, the precipitation operation of the hydroxide by alkali hydroxide is possible under conditions where pH adjustment is easily possible, and a small amount of nickel dissolved after this operation continues to be recovered as a precipitate in the following carbonation step. By use of this technique, the problem of pH adjustment requiring advanced control can be avoided and the yield of nickel and the removal rate of magnesium can be improved. However, increasing the amount of carbonation additive used in the carbonation step increases the amount of alkali metal derived from the carbonation additive incorporated into the process of repeating the reuse of nickel, so that the amount of alkali metal incorporated into the nickel increases. Ultimately, the final product nickel sulfate is contaminated with an alkali metal. Thus, the amount of carbonation additive used in this technique is limited and most of the nickel sulfate must be recovered as nickel hydroxide by alkali hydroxide addition. Therefore, due to the foregoing reasons, the load on the solid-liquid separation step is increased, so that this is not an effective technique in view of a practical technique.

When nickel is obtained as a precipitate, it is preferred from the viewpoint of solid-liquid separation to perform a precipitation operation as a nickel carbonate-containing solid, such as basic nickel carbonate. For example, Patent Document 5 discloses a method for producing basic nickel carbonate having excellent filterability by using an alkali carbonate and adding an alkali hydroxide as needed. In Patent Document 5, sodium carbonate is used as the alkali metal carbonate in Examples.

However, by use of sodium carbonate as the carbonation additive, it cannot be avoided to incorporate alkali metals such as sodium into the nickel as described above so that it is not suitable for reuse as a nickel raw material.

Thus, it is difficult to efficiently remove magnesium by the conventional solvent extraction method and crystallization method, and it is difficult to establish an economical method for simultaneously satisfying the filterability of the precipitate, the high magnesium removal efficiency and the high nickel yield even in the precipitation method.

In addition to the problem of efficiently removing magnesium, in the conventional methods, there are problems in a method for obtaining high purity nickel sulfate from nickel sulfate mixed with an alkali metal such as sodium, which remains after magnesium removal.

If sodium is incorporated into the nickel, it is also a solvent extraction method to remove it to obtain high purity nickel sulfate. For example, Patent Document 1 discloses a method for reducing impurities in a nickel solution utilizing an exchange reaction. By this method, the sodium contained in the aqueous nickel sulfate solution can be separated. By applying solvent extraction utilizing pH adjustment for a portion of nickel sulfate in need of treatment, even though the amount of by-product produced is reduced, the extraction, since it is required to repeat the extraction/reverse extraction operations, it is inevitable that a large amount of the neutralized salt is generated as a by-product from the acid and alkali used. When sulfuric acid and sodium hydroxide are used as the pH control agent, sodium sulfate is generated in large quantities. Thus, the method of removing sodium from aqueous nickel sulfate solution by the solvent extraction method is less than an economical method due to the additional need to treat a quite large amount of by-products.

It is also considered that sodium can be removed by crystallization to obtain a high purity nickel sulfate crystal as seen from the previous non-patent document 1. However, even if nickel sulfate crystals of high purity are temporarily obtained by crystallization, sodium is concentrated in the crystallization mother liquor by continuing this operation, and the amount of sodium mixed in the nickel sulfate crystals gradually increases. Then, when a certain nickel/sodium concentration ratio is reached, the double salt of nickel sulfate and sodium sulfate begins to precipitate, so that it is impossible to obtain high purity nickel sulfate crystals by crystallization operations.

Therefore, in a purification operation by use of a common crystallization method, an operation is required to discharge the crystallization mother liquor in which the impurities are concentrated, to the outside of the system at a constant rate. The crystallization method is not suitable as a method for economically removing sodium because a large amount of nickel sulfate reaching a saturation concentration with this operation should be discarded or transferred to another impurity removal step, and the cost performance for obtaining high purity nickel sulfate is greatly reduced.

### CITATION LIST

### Patent Literature

Patent Document 1: Japanese Patent Application Laid-Open (KOKAI) H10-310437
Patent Document 2: Japanese Patent Application Laid-Open (KOKAI) 2013-151717
Patent Document 3: Japanese Patent Application Laid-Open (KOKAI) 2013-203646
Patent Document 4: Japanese Patent Application Laid-Open (KOKAI) 2014-144877
Patent Document 5: Japanese Patent Application Laid-Open (KOKAI) S49-91996

### Non-Patent Literature

Non-Patent Document 1: Ina Beate Jenssen, Seniz Ucar, Oluf Bockman, Ole Morten Dotterud, Jens-Petter Andreassen, “Impurity Uptake During Cooling Crystallization of Nickel Sulfate”, Rare Metal Technology 2020, p191-199

### SUMMARY OF INVENTION

### Technical Problem

As seen from the above description, various developments have been attempted as a technique for removing magnesium impurities from nickel sulfate, but there has not been established technologies that are practical, efficient, and economical to operate.

A technique for recovering high-purity nickel by adding an alkali hydroxide or an alkali carbonate is considered to be better than the crystallization method or solvent extraction method. However, even though this method is performed, it has not been established to achieve an economical impurity removal process for recovering nickel in high yield while efficiently removing magnesium, and a process for facilitating the handling property of a precipitate by having excellent filterability of the nickel precipitate obtained in the magnesium separation process. Furthermore, it has not been established to achieve the process of keeping the amount of impurities mixed in the regenerated nickel sulfate at a low level even when repeated use of carbonated nickel and process of maintaining the quality as high purity nickel sulfate. Thus, it has not been established to solve all of these problems.

To the above problems in the prior arts, an object of the present invention is to simultaneously solve the problems associated with these magnesium removal and high purification, and to significantly improve the production of nickel sulfate from which magnesium impurities have been removed and the efficiency and economy of high purity nickel sulfate production.

### Solution to Problem

As a result of the present inventors' earnest study to solve the above problems, the following findings have been obtained.

The means disclosed in the present invention is a production process characterized in that a suitable chemical species is selected as a carbonation additive for separating nickel and magnesium and a two-stage crystallization process is applied as a process for producing nickel sulfate.

Specifically, lithium carbonate which has never been substantially attempted to be utilized, is used as a carbonation additive. The precipitate obtained in this step has not only a high precipitation rate, but also excellent filterability, thus facilitating solid-liquid separation. Solids recovered by the solid-liquid separation contain an amount of lithium as an impurity. The precipitate is regenerated into an aqueous nickel sulfate solution using sulfuric acid or an aqueous nickel sulfate solution containing excess sulfuric acid. Then, this aqueous solution is supplied to a step of alternately repeating a concentration-crystallization operation and a cooling crystallization operation, a high-purity lithium sulfate crystal is obtained by the concentration-crystallization operation, and a high-purity nickel sulfate crystal is obtained by the cooling crystallization.

Since lithium sulfate and nickel sulfate are dissolved in the cooling crystallization mother liquor, this mother liquor is recycled to the concentration-crystallization step. Since lithium sulfate and nickel sulfate do not form a double salt, the concentration-crystallization and cooling crystallization can be continuously operated without substantial raw material loss while maintaining high efficiency. Also, no generation of by-products is a factor that allows for a highly efficient continuous operation.

After the reaction of the aqueous lithium carbonate solution with the raw material solution, the liquid component produced by solid-liquid separation is an aqueous solution of magnesium and trace nickel and lithium dissolved. Lithium hydroxide is added to the aqueous solution to recover magnesium and trace amounts of nickel as solid contents. The dissolved lithium sulfate can be introduced into a concentration-crystallization step after adjusting the pH properly.

That is, in a first aspect of the present invention, there is provided a process for producing an aqueous nickel sulfate solution from which magnesium is removed from nickel sulfate, which process comprises the following steps (1) to (3):
(1) a carbonation step obtaining a slurry comprising nickel carbonate as a solid content by mixing a nickel sulfate aqueous solution and lithium carbonate,
(2) a solid-liquid separation step of separating the slurry obtained in the carbonation step into a solid content and liquid components, and
(3) a dissolution step dissolving the solid content obtained in said solid-liquid separation step with a solution containing sulfuric acid.

In a second aspect of the present invention, there is provided the process for producing an aqueous nickel sulfate solution according to the first aspect, further comprising:
a concentration-crystallization step of the lithium-containing aqueous nickel sulfate solution obtained in said (3) dissolution step of dissolving in a solution containing sulfuric acid to obtain a slurry comprising lithium sulfate as a solid content, and
a solid-liquid separation step separating the slurry obtained in the concentration-crystallization step into a solid content and liquid component to obtain a solid content of lithium sulfate crystal and a crystallization mother liquor.

In a third aspect of the present invention, there is provided the process for producing an aqueous nickel sulfate solution according to the second aspect, further comprising:
a cooling crystallization step of obtaining a slurry comprising nickel sulfate as a solid content by cooling crystallization of the crystallization mother liquor separated in the concentration-crystallization step, and
a solid-liquid separation step of separating the slurry obtained by the cooling crystallization step into a solid content and liquid component to obtain a nickel sulfate crystal as the solid content and a crystallization mother liquor as the liquid component.

In a fourth aspect of the present invention, there is provided the process for producing an aqueous nickel sulfate solution according to the second or third aspect, further comprising
a step returning the crystallization mother liquor separated in said cooling crystallization step to the concentration-crystallization step.

In a fifth aspect of the present invention, there is provided the process for producing an aqueous nickel sulfate solution according to any one of second to fourth aspects, further comprising
a step of pH adjustment and solid-liquid separation performed on the liquid component obtained in the solid-liquid separation step after the carbonation step, to obtain a solution in which dissolved carbonic acid and polyvalent metal are removed, and
a step of introducing the obtained solution into the concentration-crystallization step.

In a sixth aspect of the present invention, there is provided the process for producing an aqueous nickel sulfate solution according to any one of second to fifth aspects, wherein the operation temperature in the concentration-crystallization step is 40° C. or higher.

In a seventh aspect of the present invention, there is provided the process for producing an aqueous nickel sulfate solution according to any one of third to sixth aspects, wherein the operating temperature in the cooling crystallization step is set at not less than 20° C. lower than the operating temperature of the concentration-crystallization step.

### Advantageous Effects of Invention

In the carbonation step according to the present invention, a solid content comprising nickel carbonate is obtained as a precipitate. By appropriately controlling the reaction equivalent and the reaction temperature in this step, it is possible to recover nickel as a solid in high yield and to prevent the co-precipitation of magnesium into the solids simultaneously and easily.

Even if the amount of lithium carbonate added is less than or equal to the theoretical equivalent, nickel can be recovered with high yield and high purity, thus this is one of technical effects in the present invention. In the prior art, it has been necessary to add a carbonation agent in an amount of theoretical equivalent or more to obtain basic nickel carbonate so as to recover nickel in high yield. However, such agent is not necessary to recover the solids as obtained in the present invention, and a solid content containing nickel carbonate can be obtained more economically.

The nickel carbonate-containing solids obtained in this way can be easily subjected to solid-liquid separation due to the large sedimentation rate and excellent filterability because of the large aggregate particle size. Therefore, even a generally used filtration device can efficiently recover solids.

The nickel carbonate-containing solid contents are further dissolved in an aqueous solution containing sulfuric acid. This solution contain nickel sulfate and trace amounts of lithium sulfate. By performing a concentration-crystallization operation on this aqueous solution, the lithium sulfate crystal is obtained as a solid content, and the nickel sulfate is concentrated in the crystallization mother liquor. A high purity lithium sulfate crystal can be obtained by appropriate cleaning of the solids. The lithium sulfate obtained in this step has a quality suitable for reuse as a raw material for the production of lithium carbonate or lithium hydroxide

The concentration-crystallization mother liquor is further transferred to a cooling crystallization step so that nickel sulfate is obtained as a crystal. A high purity nickel sulfate crystal can be obtained by appropriate cleaning of the crystal

Since there is no generation of by-products associated with the crystallization operation and the lithium sulfate and nickel sulfate do not form a double salt, the concentration-crystallization and cooling crystallization can be continued to be repeated, so that the crystallization steps are a very economical because nickel and lithium are not substantially lost to the outside of the product.

The liquid component produced in the carbonation step is also a lithium sulfate solution after removal of the magnesium component, which solution can be introduced into the concentration-crystallization step. Therefore, since the waste treatment of the carbonation step and the step of recovering the valuable lithium sulfate can be carried out in one step, the process is simplified and the economic efficiency can be further enhanced.

The step of dissolving the nickel carbonate-containing solids with sulfuric acid generates carbon dioxide. If the amount of carbon dioxide generation is desired to be reduced, the carbon dioxide can be absorbed by reaction with lithium hydroxide to synthesize lithium carbonate. The lithium carbonate thus obtained can be reused as a carbonation additive for nickel sulfate. Thus, the carbon dioxide gas will be repeatedly utilized in the process and the amount continuously discharged out of the process can be significantly reduced.

### BRIEF DESCRIPTION OF DRAWINGS

FIG. 1 is a production flow diagram of high purity nickel sulfate and high purity lithium sulfate of the present invention.

FIG. 2 shows the relationship between the magnesium removal rate and the carbonation temperature for the solid contents obtained in the carbonation step in an embodiment performing the present invention.

FIG. 3 is a diagram showing the relationship between the yield of solids obtained in the carbonation step and the carbonation temperature in an embodiment performing the present invention.

FIG. 4 is a diagram showing the relationship between the yield of solids obtained in the carbonation step and the magnesium removal rate for Example performing the present invention and Comparative Example performing known techniques, respectively.

### DESCRIPTION OF EMBODIMENTS

To illustrate possible embodiments according to the invention, there is provided an example of a production flow comprising a carbonation step, a decarbonation step, a neutralization step, a dissolution step, a concentration-crystallization, a cooling crystallization and a solid-liquid separation step. However, the combination of unit operations constituting the actual process is not limited to this example, and skilled person in this art can add changes without departing from the scope of the present invention.

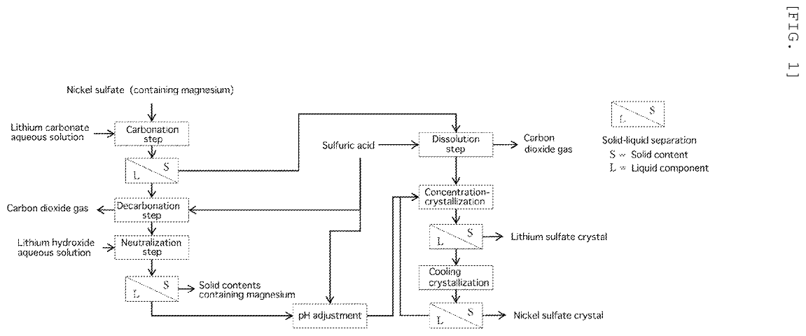

The following is described along the flow diagram shown in FIG. 1. The carbonation step comprises mixing the nickel sulfate containing magnesium as impurities and the aqueous lithium carbonate solution to precipitate the nickel carbonate-containing solid contents. The equivalent ratio of lithium carbonate to nickel is preferably 1 or less, more preferably 0.9 or less. When this control is performed, the pH of the mixed slurry is 8 or less, and if the equivalent ratio is 0.86, the pH is 7.3 or less.

The precipitation temperature is preferably 50° C. or higher. The precipitation temperature difference does not significantly affect the removal rate of magnesium, but the yield of nickel is changed. In view of the yield of nickel, the precipitation temperature is more preferably 70° C. or higher. Although operation can be performed at temperatures above 70° C., it is advantageous to perform the operation in the temperature range of around 70° C. because the materials and equipment designs of the devices that can be used are limited. In view of the above, the upper limit of the precipitation temperature is preferably 110° C.

The concentration of the source solution can be arbitrarily determined, but the nickel sulfate concentration as high as possible is more efficient. A solution of 26% by weight concentration as nickel sulfate can be readily prepared at room temperature. The higher temperature may be used to prepare a raw material solution in which more nickel sulfate is dissolved. In a case of reaction at 70° C., the raw material solution may also be warmed to 70° C. and, for example, 35% by weight nickel sulfate may be dissolved. The upper limit of the concentration of the raw material solution is preferably less than or equal to the saturation concentration that can be stably handled at the temperature at which the solution is prepared.

Since the nickel carbonate-containing solids are easy to precipitation, a proper stirring is required in the reactor. For the stirring method, any known methods may be used and may be selected as appropriate.

The carbonation step may be performed in a batch, continuous, or semi-batch manner. However, it is preferable to ensure that the residence time or reaction time of the slurry in the reactor is one hour or more. If this time is too short, the reaction of lithium carbonate with nickel sulfate may not be completed. Although the reaction is complete if the residence time or reaction time of the slurry is too long, the reaction is inefficient in time, so that the time is usually ensured for 5 hours or less.

In the course of advancing the reaction, it is not preferred to undergo such conditions that the equivalent ratio exceeds the above ratio, even though in a local portion. If the excess amount of lithium carbonate is mixed with nickel sulfate, the magnesium may co-precipitate. However, if the raw material concentration is known in advance, it can be readily accomplished to maintain the predetermined flow rate and the addition amount by use of a suitable flow meter and flow control device such as a control valve. Also, for similar reasons, the operation of charging an aqueous solution of nickel sulfate into an aqueous solution of lithium carbonate is not preferable. However, the operation of adding a lithium carbonate solution to a predetermined equivalent ratio in an aqueous nickel sulfate solution is possible. Also, a lithium carbonate aqueous solution and a nickel sulfate solution may be mixed up to an amount equal to or less than a predetermined equivalent ratio, and a small amount of aqueous lithium carbonate solution may be added while monitoring the pH.

The nickel carbonate-containing solid content obtained in the carbonation step are separated to a solid content and liquid component by a solid-liquid separation step. As a solid-liquid separator, any suitable equipment may be selected, such as vacuum filtration-type, pressure filtration-type, or the like. In the conventional method for recovering nickel carbonate by a carbonation method, since a large amount of nickel is dissolved under the condition that the magnesium removal rate is increased, the amount of nickel that cannot be recovered with magnesium as a liquid component in the solid-liquid separation step is very high, and this is significantly different from the effect attained by the present invention.

The solids obtained in this step are regenerated into an aqueous nickel sulfate solution by adding sulfuric acid. The nickel sulfate concentration can optionally be set, but it is preferred to set the concentration as high as possible in order to advantageously perform the subsequent concentration-crystallization step. In conventional carbonation methods, sodium derived from a carbonizing agent is mixed into a nickel-containing precipitate. Therefore, even if a high-purity nickel sulfate is obtained by a crystallization method, sodium sulfate concentrated in the crystallization mother liquor forms a double salt with nickel sulfate so that separation purification thereof was difficult. However, in the present invention, by using lithium carbonate as a carbonation additive, it is possible to solve the problem of double salt formation in the crystallization step and obtain high purity nickel sulfate.

The lithium-containing aqueous nickel sulfate solution obtained in the dissolution step is subjected to a concentration-crystallization operation in a known manner using a combination of either warming or reduced pressure, or both. Since lithium sulfate has a property of decreasing solubility as the temperature is higher, it is advantageous to perform the concentration-crystallization operation in a high temperature range, but since the equipment cost increases when the temperature is too high, it is practically maintained in a temperature range of 40° C. to 110° C., preferably from 60° C. to 90° C.

The lithium sulfate crystals obtained by the concentration-crystallization operation are separated in solid contents by a solid-liquid separator. Although a centrifuge is usually used as this device, any other forms may be used. The solid-liquid separation step also comprises cleaning the obtained crystals with an aqueous medium such as water, hot water or a high purity aqueous lithium sulfate solution. It is also possible to use a cleaning liquid such as ethanol in which lithium sulfate is difficult to dissolve. Therefore, in consideration of an increase in waste liquid treatment cost, a suitable cleaning liquid may be selected. If cleaning the crystals with water, warm water or aqueous lithium sulfate, the cleaning effluent can be returned to the concentrate-crystallization step.

A portion of the concentration-crystallization mother liquor is withdrawn and transferred to a cooling crystallizer. When the solution with increased nickel concentration by the concentration-crystallization operation is cooled, nickel sulfate is precipitated as a crystal by a solubility change.

The obtained crystals are also cleaned by appropriate solid-liquid separation and cleaning equipment. Typically, a centrifuge is used, and an aqueous medium such as a small amount of water, cold water or a high purity aqueous nickel sulfate solution is used as the cleaning fluid. Although this cleaning waste solution can be returned to the cooling crystallization process, it is advantageous in operation to return to the concentration-crystallization process because the efficiency of the cooling crystallization is reduced.

A portion of the cooled crystallization mother liquor is withdrawn and returned to the concentrate crystallizer. The lithium sulfate remaining in the mother liquor produce crystals by the concentration-crystallization operation and the nickel sulfate is concentrated again.

Since the solubility of nickel sulfate decreases with decreasing temperature, it is preferred to carry out the cooling crystallization operation at a lower temperature, but the temperature range is generally maintained within a range of 10° C. to 60° C. because the cooling cost tends to increase if the set temperature is too low. When the difference from the operating temperature of the concentration-crystallization step is small, the efficiency of precipitating the crystal in each step is reduced. Therefore, it is preferable to set the temperature difference to 30° C. or higher. For example, the concentration-crystallization can be operated at 70° C. and the cooling crystallization can be operated at 35° C. to reduce the load of warming and cooling operations.

As the cooling crystallization, Eutectic Freeze Crystallization may also be applied. Using this technique, since water crystals (ice) are produced as suspended matter in the process of obtaining nickel sulfate crystals as a precipitate, it can be attained to concentrate the crystallization mother liquor simultaneously by the solid-liquid separation thereof. As long as the crystal of lithium sulfate does not precipitate during the cooling crystallization operation, the evaporation energy required to concentrate the solution as a whole system can be saved without departing from the spirit of the present invention.

The liquid component generated in the carbonation step followed by the solid-liquid separation step contains lithium sulfate and trace nickel and magnesium. Also, since very small amounts of carbonate ions remain therein, sulfuric acid is previously added to reduce the pH and liberate the carbon dioxide gas. At this time, the pH is preferably controlled to 4 or less. A vacuum operation may also be performed in combination in order to accelerate the degassing of the generated carbon dioxide gas.

The neutralization step is followed by removing trace amounts of nickel and magnesium dissolved by neutralization as solids. Any alkali hydroxide can be selected for the neutralizing agent, but lithium hydroxide is preferably used if the liquid is treated in the crystallization step. When a liquid component is supplied to the crystallization step using other alkali hydroxides, the concentration of impurities in the lithium sulfate obtained in the crystallization step is increased.

The neutralization step is adjusted to a pH at which nickel and magnesium are sufficiently precipitated. The pH is preferably 8 or greater, and more preferably the pH is 10 or greater.

The liquid component obtained by the neutralization step and the solid-liquid separation step is an aqueous solution of lithium sulfate. If this solution is introduced into the crystallization step, sulfuric acid is added so that the lithium ions and sulfate ions are stoichiometric in advance. The pH of the lithium sulfate solution is preferably adjusted to about 3.5 to 6.0.

The magnesium content in the high purity nickel sulfate obtained according to the present invention is typically 300 (mg (Mg)/kg (Ni)) or less, preferably 100 (mg (Mg)/kg (Ni)) or less as the content of elemental magnesium normalized with the content of elemental nickel.

### EXAMPLES

The present invention is described in more detail by showing Examples of carbonation and crystallization steps below. The analysis methods used in the following Examples are shown.

The nickel content in the raw material solution and the nickel content contained at high concentrations in the solid contents recovered after the carbonation step were determined by a known chelating titration method using a copper ion selective electrode.

The contents of nickel, lithium and magnesium contained in low concentrations were measured by use of ICP emission spectroscopic analyzer iCAP 6500 Duo (manufactured by Thermo Fisher Scientific Inc.).

The pH of the slurry obtained by the carbonation step was measured by use of a pH meter (HM-30P, manufactured by DKK-TOA CORPORATION)

### Examples 1-4

### <The Separation of Nickel and Magnesium and the Yield of Nickel in the Carbonation Step>

The simulated raw material solution was prepared in such a manner that a nickel sulfate concentration was 316 g/L and a magnesium sulfate concentration was 371 mg/L. About 40 mL of the solution was measured and transferred to a 1 L stainless vessel. An aqueous solution of lithium carbonate (the concentration shown in Table 1) was prepared as a carbonation additive and added to the above simulated solution at an equivalent ratio shown in Table 1 over about 90 minutes while maintaining each temperature of 50° C. (Example 1), 60° C. (Example 2), 70° C. (Example 3) and 80° C. (Example 4). During preparation and practice of these operations, the content of vessel was kept sufficiently stirred. After the addition was complete, only the liquid component was sampled at a predetermined retention time and the amount of magnesium contained in the liquid was analyzed. The pH of slurry after a 5-hour holding time was measured. Solid-liquid separation was carried out by vacuum filtration using a Buchner funnel, and the resulting solid cake was washed with water. These treatment conditions are shown in Table 1. The magnesium content shown in Table 1 is the magnesium element content (mg (Mg)/kg (Ni)) normalized by the nickel element content.

TABLE 1

| | Carbonation | Amount of | Amount of | Concentration |
|---|---|---|---|---|
| | treatment | NiSO₄ | Li₂CO₃ | of Li₂CO₃ |
| | temperature | treated | treated | solution |
| No. | [° C.] | [g] | [g] | [g/L] |
| Example 1 | 50 | 12.7 | 5.20 | 12.1 |
| Example 2 | 60 | 13.0 | 5.32 | 9.5 |
| Example 3 | 70 | 12.7 | 5.18 | 8.8 |
| Example 4 | 80 | 12.7 | 5.18 | 8.8 |

| | | Mg concentration in the liquid | | |
|---|---|---|---|---|
| | Equivalent | after complete of addition | | |
| | ratio | 1 hour | 3 hours | 5 hours |
| No. | [—] | [mg/L] | [mg/L] | [mg/L] |
| Example 1 | 0.86 | — | — | 5.1 |
| Example 2 | 0.86 | 5.0 | 4.6 | 4.9 |
| Example 3 | 0.86 | 4.6 | 4.6 | 4.9 |
| Example 4 | 0.86 | — | 4.2 | 4.6 |

| | | Mg content to | Mg amount in the |
|---|---|---|---|
| | | Ni content in | solid contents |
| | | the simulated | after the |
| | Final pH of slurry | solution | carbonation |
| No. | [—] | [mg (Mg)/kg (Ni)] | |
| Example 1 | 7.2 | 625 | 66 |
| Example 2 | 7.1 | | 35 |
| Example 3 | 7.1 | | 77 |
| Example 4 | 7.2 | | 51 |

As seen from Table 1, it can be confirmed that the magnesium concentration in the slurry solution held for one hour after the addition of the aqueous lithium carbonate solution was changed very quite little in comparison with those held for three and five hours. Therefore, it is clear that the reaction time required to complete the carbonation reaction sufficiently is within one hour.

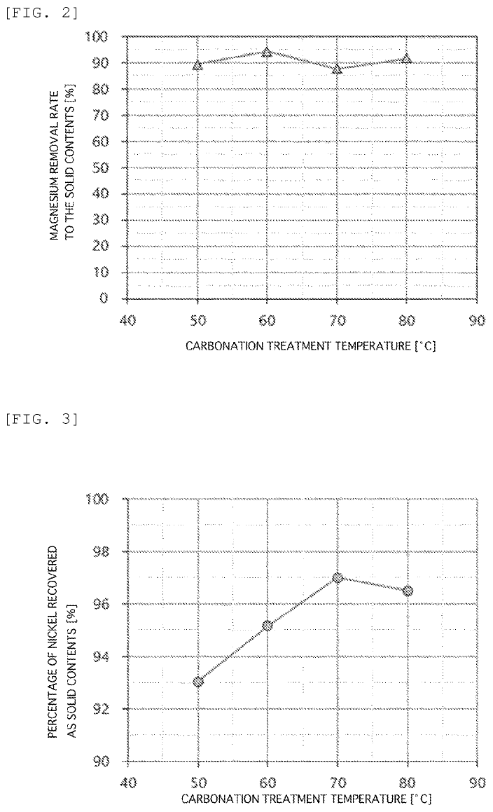

FIG. 2 shows the percentage of magnesium contained in the simulated mother liquor and dissolved in the liquid without migration into the nickel precipitate, that is, the magnesium removal rate to solid contents. In either treatment condition, it is confirmed that the removal rate is high and about 90%.

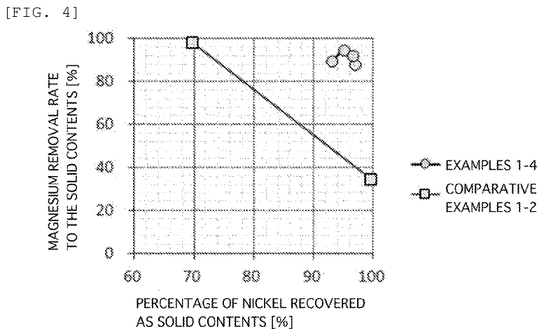

FIG. 3 shows the percentage of nickel recovered as solid components, that is, the yield of nickel. As seen form the figure, the yields of nickel at the processing temperature of 70 and 80° C. are higher than those at 50 and 60° C.

### Comparative Example 1

### <The Separation of Nickel and Magnesium and the Yield of Nickel in the Carbonation Process According to the Prior Art>

Experiments were conducted based on the prior art for magnesium removal using sodium carbonate as a carbonation additive. The same treatment as in Example 1 was conducted except that the holding temperature of the reaction vessel was set to 40° C., an aqueous solution of sodium carbonate was used instead of the aqueous solution of lithium carbonate to prepare a 3.10% by weight of carbonation additive solution, and the equivalent ratio of sodium carbonate to nickel sulfate was 0.68.

### Comparative Example 2

The same experiment as in Comparative Example 1 was conducted except that the equivalent ratio of sodium carbonate to nickel sulfate was changed to 1.18.

FIG. 4 shows, for the samples obtained in Comparative Examples 1-2, the relationship between the percentage of nickel recovered as solids and the magnesium removal rate of solids in combination with the results of Examples 1-4.

As seen from FIG. 4, it can be confirmed that in Examples according to the present invention, both a high nickel recovery rate (about 80% or more) as a solid content and a high magnesium removal rate (about 80% or more) are attained compatibly, whereas Comparative Examples according to the prior art is not attained compatibly.

### Example 5

### <The Filtration Rate of the Solids Cake Obtained in the Carbonation Step>

The same reaction of carbonation as in Example 4 was carried out except that about 75 mL of the raw material solution was used, a 2 L stainless vessel was used as the reaction vessel, and the retention time after the addition of lithium carbonate was 3 hours.

The obtained slurry was subjected to solid-liquid separation by vacuum filtration using a Buchner funnel and filter paper No. 5C (90 mm in diameter, manufactured by ADVANTECH CO., LTD.). After all solid contents were recovered as a cake on the filter paper, approximately 1.8 L of water was added to the funnel in such a manner that the water was divided into three times in the total amount, and the filtration rate of the wash water was measured. The filtration rate was 191-257 g/min. The results are shown in Table 2.

### Comparative Example 3

### <The Filtration Rate of the Solids Cake Obtained by the Alkali Hydroxide Process According to the Prior Art>

The same precipitation reaction and filtration rate measurements as in Example 5 were carried out except that 65 mL of the raw material solution was used, a 2 L stainless vessel was used as the reaction vessel, the equivalent ratio of the additive was 0.9 using a lithium hydroxide aqueous solution as the precipitation additive, and the amount of wash water was 200 mL. At this time, the concentration was adjusted so that the lithium concentration in the aqueous lithium hydroxide solution was the same as the lithium concentration in the aqueous lithium carbonate solution in Example 5. The results are shown in Table 2.

### Comparative Example 4

### <The Filtration Rate of the Solids Cake Obtained in the Carbonation Process According to the Prior Art>

The same reaction of carbonation as in Example 5 was carried out except that sodium carbonate was used as the precipitation additive.

The obtained slurry was subjected to solid-liquid separation by vacuum filtration using a Buchner funnel and filter paper No. 5C (90 mm in diameter, manufactured by ADVANTECH CO., LTD.). After all solid contents were recovered as a cake on the filter paper, approximately 1.8 L of water was added to the funnel in such a manner that the water was divided into three times in the total amount, and the filtration rate of the wash water was measured. The filtration rate was 116-167 g/min. The results are shown in Table 2.

TABLE 2

| | Used amount of | Concentration | Concentration |
|---|---|---|---|
| | raw material | of Li₂CO₃ | of LiOH |
| | solution | solution | solution |
| No. | [mL] | [g/L] | [g/L] |
| Example 5 | 75 | 8.9 | — |
| Comp. | 65 | — | 5.8 |
| Example 3 | | | |
| Comp. | 75 | — | — |
| Example 4 | | | |

| | Concentration | | Concentration |
|---|---|---|---|
| | of lithium in | Concentration | of sodium in |
| | the additive | of Na₂CO₃ | the additive |
| | solution | solution | solution |
| No. | [g/L] | [g/L] | [g/L] |
| Example 5 | 1.7 | — | — |
| Comp. | 1.7 | — | — |
| Example 3 | | | |
| Comp. | — | 13.1 | 5.7 |
| Example 4 | | | |

| | Concentration of | | |
|---|---|---|---|
| | alkali in the | Equivalent | Yield of |
| | additive solution | ratio | nickel |
| No. | [mol/L] | [—] | [%] |
| Example 5 | 0.24 | 0.86 | 95.0 |
| Comp. | 0.24 | 0.90 | 95.5 |
| Example 3 | | | |
| Comp. | 0.25 | 0.86 | 94.2 |
| Example 4 | | | |

| | Amount of solid | Filtration average |
|---|---|---|
| | contents recovered | rate of the wash |
| | (dry weight) | water |
| No. | [g] | [g/min] |
| Example 5 | 17.0 | 226 |
| Comp. | 12.0 | 3.3 |
| Example 3 | | |
| Comp. | 17.3 | 140 |
| Example 4 | | |

As seen from Table 2, it can be confirmed that the yield of nickel is approximately the same for Example 5 and Comparative Examples 3 and 4. It is clear that the solid contents cake obtained in Example 5 is significantly more filterable than those obtained in Comparative Example 3. In addition, Comparative Example 4 using sodium carbonate as the additive, it is clear that the filterability of Example 5 is significantly superior to those obtained in Comparative 4.

### Example 6

### <Separation of Nickel Sulfate and Lithium Sulfate by Crystallization Operations>

A simulated mother liquor was prepared from nickel sulfate and a lithium sulfate reagent in order that even when lithium is concentrated in the crystallization mother liquor, lithium sulfate can be separated by concentration-crystallization in accordance with the present invention, and to confirm that high purity nickel sulfate crystals can be obtained by the crystallization method in subsequent cooling crystallization. The simulated mother liquor contained nickel sulfate and lithium sulfate in an amount of 5.08% by weight in terms of metallic nickel and in an amount of 1.23% by weight in terms of metallic lithium, respectively

3.2 L of the simulated mother liquor was placed in a crystallization vessel with a heat-retaining jacket. In order to warm the vessel, hot water adjusted to 90-93° C. was flowed at a flow rate of 5.5 L/min in an insulated jacketing. Further, the operation of controlling the absolute pressure in the vessel between 35 and 38 kPa by a vacuum operation was continued during the concentration-crystallization so that the inside of the crystallization vessel is kept at 80° C. In addition, the solution in the vessel was kept sufficiently stirred during the crystallization operation.

A raw material solution of the same composition as the simulated mother liquor was continuously fed into such a controlled crystallizer to generate crystals of lithium sulfate at approximately 5.8 hours. A total amount of about 18 kg of the raw material was fed over 32 hours. After the crystal began to occur, the slurry was intermittently withdrawn so that the solids concentration in the vessel was controlled to 12% by weight and solid-liquid separation was carried out with a centrifuge. The solid contents obtained by this operation were washed with a high purity aqueous lithium sulfate solution.

When the raw material of the concentration-crystallization was completed, the total amount of the slurry in the crystallization vessel was removed and was subjected to the solid-liquid separation by a centrifuge. The resulting liquid component was transferred to a vessel insulated at 80° C. together with the liquid component obtained in the intermittent extraction operation during the concentration-crystallization procedure, which was a raw material solution of cooling crystallization.

The simulated mother liquor used in the concentration-crystallization was concentrated to 1.52 times as a starting mother liquor for the cooling crystallization, and 3.1 L of this concentrate was placed in a crystallization vessel. The temperature of the cooling water passing through the thermal insulation jacket was controlled so that the interior of the vessel was kept at 25° C. during the cooling crystallization.

The raw material solution of cooling crystallization was continuously fed to precipitate crystals of nickel sulfate. The raw material of cooling crystallization was continuously fed over about 17 hours. During the cooling crystallization operation, the slurry was intermittently withdrawn such that the amount of slurry in the crystallization vessel was substantially constant. Solid-liquid separation of the extracted slurry was conducted by a centrifuge, and the solid contents obtained by this operation were washed with a high-purity aqueous nickel sulfate solution.

The results of the analysis of crystals, simulated mother liquor and crystallization mother liquor after completion of cooling crystallization obtained in the series of operations are shown in Table 3.

TABLE 3

| | Ni | Li |
|---|---|---|
| Sample | [% by weight] | [% by weight] |
| Concentration-crystallization | 5.08 | 1.23 |
| raw material solution | | |
| Lithium sulfate crystal | 0.0186 | 10.5 |
| Concentration-crystallization | 11.4 | 1.15 |
| mother liquor (at the above | | |
| sampling of crystal) | | |
| Nickel sulfate crystal | 22.4 | 0.0088 |
| Mother liquor after the | 7.4 | 1.85 |
| cooling crystallization | | |

As seen from Table 3, it can be confirmed that high purity lithium sulfate crystal and high purity nickel sulfate crystal are obtained, respectively, despite the use of nickel sulfate simulated mother liquor containing a higher concentration of lithium sulfate.

The concentration of nickel sulfate and lithium sulfate proceeds through the concentration-crystallization operation, but since lithium sulfate precipitates as a crystal, the lithium ratio in the concentration-crystallization mother liquor was decreased. Then, since the cooling crystallization mother liquor has the nickel/lithium ratio equal to those of the raw material solution, it can be seen that the cooling crystallization mother liquor can be returned to the concentration-crystallization step and repeatedly utilized for the crystallization of lithium sulfate crystals.

From the above results, by use of lithium carbonate as the additive for the carbonation step according to the present invention, it can be attained to effectively separate nickel and magnesium and to obtain a precipitate having excellent filterability. Further, after regenerating the precipitate into an aqueous nickel sulfate solution, the nickel sulfate and lithium sulfate contained in the aqueous solution are separated by the concentration-crystallization and cooling crystallization according to the present invention to obtain high purity nickel sulfate. The magnesium contained in the raw material can be removed out of the system via the neutralization step, and lithium derived from the carbonation additive is recovered as lithium sulfate in the crystallization step, so that impurities do not accumulate in the step of purifying nickel sulfate and do not affect the nickel sulfate crystals which are products. Thus, nickel sulfate from which magnesium has been removed can be continuously obtained in high yield as an aqueous solution or crystal as the whole purification process.

### INDUSTRIAL APPLICABILITY

The process for producing high-purity nickel sulfate according to the present invention is readily adaptable to conventional devices, enables efficient production of nickel sulfate in high yield, and is highly economical because chemicals other than the objects generated in each step can be reused.

1. A process for producing an aqueous nickel sulfate solution from which magnesium is removed from nickel sulfate, which process comprises the following steps (1) to (3):
(1) a carbonation step obtaining a slurry comprising nickel carbonate as a solid content by mixing a nickel sulfate aqueous solution and lithium carbonate,
(2) a solid-liquid separation step of separating the slurry obtained in the carbonation step into a solid content and liquid component, and
(3) a dissolution step dissolving the solid content obtained in said solid-liquid separation step with a solution containing sulfuric acid.

2. The process for producing an aqueous nickel sulfate solution according to claim 1, further comprising:
a concentration-crystallization step of the lithium-containing aqueous nickel sulfate solution obtained in said (3) dissolution step of dissolving in a solution containing sulfuric acid to obtain a slurry comprising lithium sulfate as a solid content, and
a solid-liquid separation step separating the slurry obtained in the concentration-crystallization step into a solid content and liquid component to obtain a solid content of lithium sulfate crystal and a crystallization mother liquor.

3. The process for producing an aqueous nickel sulfate solution according to claim 2, further comprising:
a cooling crystallization step of obtaining a slurry comprising nickel sulfate as a solid content by cooling crystallization of the crystallization mother liquor separated in the concentration-crystallization step, and
a solid-liquid separation step of separating the slurry obtained by the cooling crystallization step into a solid content and liquid component to obtain a nickel sulfate crystal as the solid content and a crystallization mother liquor as the liquid component.

4. The process for producing an aqueous nickel sulfate solution according to claim 2, further comprising
a step returning the crystallization mother liquor separated in said cooling crystallization step to the concentration-crystallization step.

5. The process for producing an aqueous nickel sulfate solution according to claim 2, further comprising
a step of pH adjustment and solid-liquid separation performed on the liquid component obtained in the solid-liquid separation step after the carbonation step, to obtain a solution in which dissolved carbonic acid and polyvalent metal are removed, and
a step of introducing the obtained solution into the concentration-crystallization step.

6. The process for producing an aqueous nickel sulfate solution according to claim 2, wherein the operation temperature in the concentration-crystallization step is 40° C. or higher.

7. The process for producing an aqueous nickel sulfate solution according to claim 3, wherein the operating temperature in the cooling crystallization step is set at not less than 20° C. lower than the operating temperature of the concentration-crystallization step.
